(19) United States
(12) Patent Application Publication
(10) Pub. No.: US 2015/0142147 A1
(43) Pub. Date: May 21, 2015

(54) AUDIO SYSTEM FOR RHYTHM-BASED ACTIVITY

(71) Applicant: Spring Moves, New York, NY (US)

(72) Inventors: Mattias Stanghed, New York, NY (US); Gabriel Wurzel, New York, NY (US)

(21) Appl. No.: 14/542,083

(22) Filed: Nov. 14, 2014

Related U.S. Application Data
(60) Provisional application No. 61/904,875, filed on Nov. 15, 2013.

(51) Int. Cl. G06F 17/30; G06F 3/16

(52) U.S. Cl. CPC G06F 17/30743; G06F 3/165
USPC 700/94

(57) ABSTRACT

Methods, systems, and apparatus for generating an audio experience are described. A tempo value of an activity is obtained and one or more songs characterized by a tempo that matches the obtained tempo value are identified. A playlist of songs that match the obtained tempo value is generated.

### CLAIM OF PRIORITY

This application claims the benefit and priority of U.S. Provisional Patent Application Ser. No. 61/904,875, filed Nov. 15, 2013, the disclosure of which is incorporated by reference herein.

### TECHNICAL FIELD

The present application relates generally to audio systems, and more specifically, in one example, to an audio system for supporting rhythm-based activity.

### BACKGROUND

Audio systems are often used to provide background music for a variety of activities. Music may accompany activities as varied as running and weightlifting to office work and housework. The audio systems that provide the music may be portable devices, such as smartphones, MP3 players, compact disk (CD) players, and the like, or may be console systems, such as home theater systems and stereo systems, and the like. The audio systems may be integrated with WiFi and/or cloud-based network capabilities to, for example, allow streaming of audio to audio system. Users may create playlists of a sequence of user-selected songs or may choose predefined playlists based on, for example, a certain genre of music.

### BRIEF DESCRIPTION OF THE DRAWINGS

Some embodiments are illustrated by way of example and not limitation in the figures of the accompanying drawings in which:

FIG. 1 shows a block diagram of an example system for providing an audio experience, in accordance with an example embodiment;

FIG. 2 is a block diagram of an example apparatus for providing an audio experience, in accordance with an example embodiment;

FIG. 3 shows an example tempo table for determining a default tempo value, in accordance with an example embodiment;

FIG. 4A is a flowchart of a first example method for determining a user's tempo, in accordance with an example embodiment;

FIG. 4B is a flowchart of a second example method for determining a user's tempo, in accordance with an example embodiment;

FIGS. 5A-5D illustrate an example user interface for determining a user's tempo, in accordance with an example embodiment;

FIG. 6 is a flowchart of a first example method for generating an audio session, in accordance with an example embodiment;

FIG. 7 is a flowchart of a second example method for generating an audio session, in accordance with an example embodiment;

FIG. 8 is a flowchart of a third example method for generating an audio session, in accordance with an example embodiment;

FIG. 9 shows the tempo of a micro portion of a song before re-shifting and after re-shifting, in accordance with an example embodiment;

FIG. 10 is a flowchart of an example method for automatically re-shifting portions of a song, in accordance with an example embodiment;

FIG. 11 illustrates the tempo of two songs that have been synchronized, in accordance with an example embodiment;

FIG. 12 is a flowchart of an example method for synchronizing the beats of two sequential songs, in accordance with an example embodiment;

FIG. 13 is a flowchart of an example method for creating an interval-based audio session, in accordance with an example embodiment;

FIGS. 14A and 14B illustrate an example workflow 1400 for interacting with an example interval-based audio session, in accordance with an example embodiment;

FIGS. 15A and 15B illustrate a sequence of example intervals for an interval-based audio session, in accordance with an example embodiment;

FIGS. 16A and 16B illustrate a sequence of example intervals for an interval-based audio session, in accordance with an example embodiment;

FIG. 17 is a flowchart of an example method for overlaying coaching tools, in accordance with an example embodiment;

FIG. 18 is a flowchart of an example method for generating audio cues, in accordance with an example embodiment;

FIG. 19 illustrates an example user interface for configuring voice feedback, in accordance with an example embodiment;

FIG. 20 is a flowchart of an example method for rating songs, in accordance with an example embodiment;

FIG. 21 is a flowchart of a first example method for integrating social media with an audio session, in accordance with an example embodiment;

FIG. 22 is a flowchart of a second example method for integrating social media with an audio session, in accordance with an example embodiment;

FIG. 23 is a block diagram illustrating an example mobile device, according to an example embodiment; and

FIG. 24 is a block diagram of a machine within which instructions may be executed for causing the machine to perform any one or more of the methodologies discussed herein.

### DETAILED DESCRIPTION

In the following detailed description of example embodiments, reference is made to specific examples by way of drawings and illustrations. These examples are described in sufficient detail to enable those skilled in the art to practice these example embodiments, and serve to illustrate how the invention may be applied to various purposes or embodiments. Other embodiments of the invention exist and are within the scope of the invention, and logical, mechanical, electrical, and other changes may be made without departing from the scope or extent of the present invention. Features or limitations of various embodiments of the invention described herein, however essential to the example embodiments in which they are incorporated, do not limit the invention as a whole, and any reference to the invention, its elements, operation, and application do not limit the invention as a whole but serve only to define these example embodiments. The following detailed description does not, therefore, limit the scope of the invention, which is defined only by the appended claims.

Generally, methods, systems, apparatus, and articles of manufacture for generating audio tracks to accompany human activities are described. An audio track may be a track of music, songs, audio cues, verbal instructions, and the like and may be immediately rendered into audio or stored for future use and rendered into audio in the future. In one example embodiment, a streaming audio experience designed to accompany rhythm-based physical activity is generated. The activity may be repetitive in nature. Example activities include walking, running, cycling, swimming, aerobics, dish washing, clothes folding, assembly line work, and the like. Popular repetitive rhythmic movement (cadence) based activities such as walking, running, and swimming may have relatively narrow tempo ranges that may reflect differences in human skeletal geometry and biomechanics. Walkers may, for example, tend to take between 110 and 130 steps per minute while runners may take between 150 and 180 steps per minute depending on factors such as speed, runner height, and stride length.

The audio experience may be delivered via a cloud or Wi-Fi based infrastructure, or may be delivered via a variety of physical media. In one example embodiment, the tempo of the audio experience, such as the tempo of music or songs, may be chosen to match the tempo of the activity. For example, a song may be selected such that the beats per minute of the song match the steps per minute of a runner. In one example embodiment, the song may be selected based on the user's (such as the runner's) musical taste, including preferred genres, artists, moods, songs, and the like. When runners, walkers, cyclists, swimmers, and the like synchronize their physical movements to a particular musical tempo, their physical performance may be improved.

In one example embodiment, a tempo of a song or a portion of a song may be adjusted to augment songs available for a particular tempo range or to match the desired tempo of a user or activity. For example, the tempo of a song may be adjusted to be slower or faster than the original tempo of the song. In some situations, the tempo of a song may change during the course of the song due to stylistic choices, imprecise performances, and the like. In some situations, it is desirable to vary the tempo of a song, such as when a jogger desires to vary his or her speed. In other situations, when a user seeks to pair music to a rhythmically repetitive behavior, such as walking or jogging at a fixed speed, it may be desirable for the beat or pulse of the music to remain as close as possible to a fixed grid or meter. In one example embodiment, portions of a song may be re-shifted to fit a rhythmic grid. This effect is known as beatgridding.

In one example embodiment, in order to maintain a smooth pace from one song to the next, the beats at the beginning of the next song in a sequence of songs may be synchronized, or lined up, with the beats of the previous song in the sequence of songs to create a seamless transition between the songs. For example, the next song in a sequence of songs may be delayed in relation to a preceding song in the sequence of songs to synchronize the beats.

In some instances, an activity may change tempo over a single session. For example, a runner may warm-up at a slow pace, run at alternating moderate and fast paces, and then cool down at a slow pace. In one example embodiment, a portion of a song, an entire song, a plurality of songs, and/or a combination of the above may be selected for each interval of the activity, where the selected songs match the tempo of the activity during the time period of the corresponding interval. A playlist may be created of songs that conform to the tempo of each interval of the audio session.

In one example embodiment, coaching tools and audio cues may be overlaid on the audiotrack to provide additional information to the listener. Coaching tools may include activity instructions, inspirational messages, rhythm-assistance tools, and the like. For example, an audio coaching tool, such as a metronome, may be overlaid on the audio selection(s) to assist a user in finding the beat of a song. In one example embodiment, voice cues may be overlaid on the audio selection(s) and may be used to notify the user of, for example, quantitative performance data such as pace, time, distance traveled, calories burned, and the like.

In one example embodiment, a multifaceted social component provides positive reinforcement to help a user achieve an activity goal(s). For example, a user may be able to interact with friends as a means to receive positive reinforcement, such as encouraging audio messages, during the performance of the activity.

In one example embodiment, a gaming experience is created with a ranking system based on the number of coins that have been accumulated over one or more audio sessions, as described more fully below. The gaming experience creates, for example, a friendly competition, such as a competition to see who can run the fastest. The gaming data may be shared via social networking platforms or directly with other users to facilitate motivation and friendly competition.

In one example embodiment, during or following an audio session, a user is able to provide subjective feedback regarding, for example, the audio experience. The feedback information may be stored and may be utilized for subsequent audio sessions of the listener or other users to improve the audio experience. For example, the songs, artist(s), mood(s), and/or genre(s) of the music selections may be adjusted based on the feedback of the user.

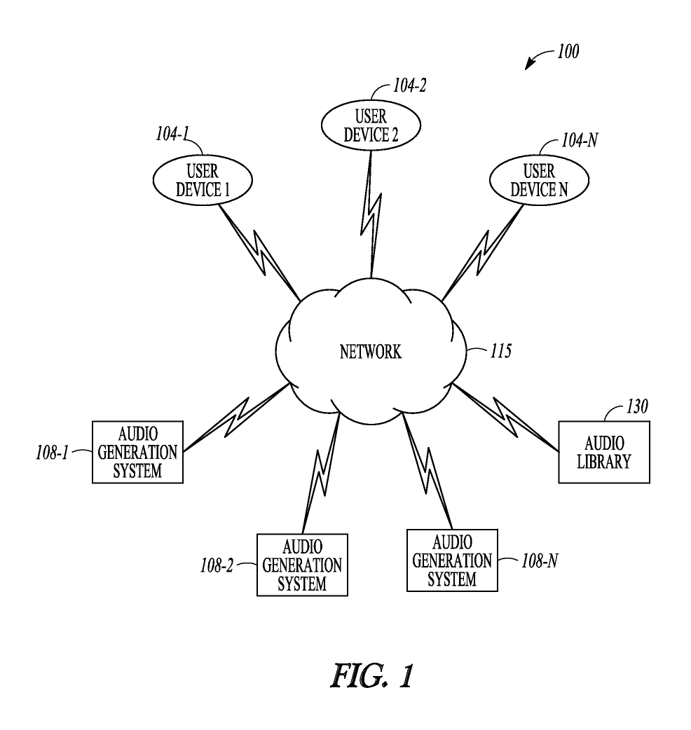

FIG. 1 shows a block diagram of an example system 100 for providing an audio experience, in accordance with an example embodiment. In one example embodiment, the system 100 may comprise one or more user devices 104-1, 104-2 and 104-N (known as user devices 104 hereinafter), one or more audio generation systems 108-1, 108-2 and 108-N (known as audio generation systems 108 hereinafter), an audio library 130, and a network 115. Each user device (e.g., 104-1) may be a smart phone, a personal computer (PC), a mobile phone, a personal digital assistant (PDA), an mp3 player, smart watch, or any other appropriate computer device. Each user device (104-1, 104-2 or 104-N) may include a user interface module that may comprise a web browser program and/or and application user interface. Although a detailed description is only illustrated for user device 104-1, it is noted that each of the other user devices (e.g., user device 104-2 through user device 104-N) may have corresponding elements with the same functionality.

The audio generation systems 108 may be a server, client, or other processing device that includes an operating system for executing software instructions. The audio generation systems 108 may provide a customizable audio experience to a variety of users. For example, the audio generation systems 108 may generate an audiotrack comprising songs characterized by a tempo that matches to the tempo of a user performing one or more activities.

The network 115 may be a local area network (LAN), a wireless network, a metropolitan area network (MAN), a wide area network (WAN), a wireless network, a network of interconnected networks, the public switched telephone network (PSTN), and the like.

The audio library 130 may comprise songs and other music, audio cues, verbal instructions, audio messages, and the like. The audio library 130 may be accessed by the audio generation systems 108 to create the audio experience.

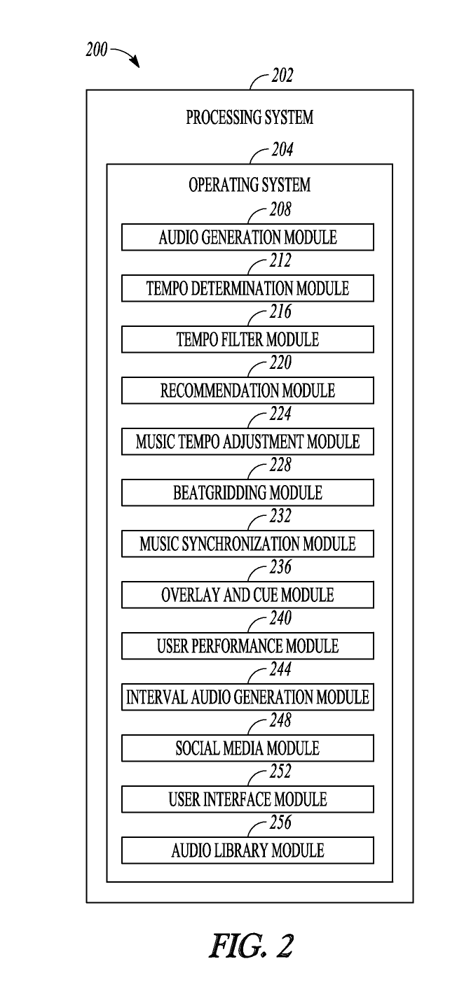

FIG. 2 is a block diagram of an example apparatus 200 for providing an audio experience, in accordance with an example embodiment. The apparatus 200 is shown to include a processing system 202 that may be implemented on a client or other processing device that includes an operating system 204 for executing software instructions. Portions of the apparatus 200 may be part of the user device 104 and/or the audio generation system 108.

In accordance with an example embodiment, the apparatus 200 may include an audio generation module 208, a tempo determination module 212, a tempo filter module 216, a recommendation module 220, a music tempo adjustment module 224, a beatgridding module 228, a music synchronization module 232, an overlay and cue module 236, a user performance module 240, an interval audio generation module 244, a social media module 248, a user interface module 252, and an audio library module 256. In one example embodiment, the apparatus 200 may include a global positioning satellite (GPS) interface module to obtain GPS data for a user from a GPS device, as described more fully below.

In one example embodiment, the audio generation module 208 generates an audio experience based on one or more activities of a user. The audio generation module 208 manages the generation of audio tracks and may coordinate activity between the tempo determination module 212, the tempo filter module 216, the recommendation module 220, the music tempo adjustment module 224, the beatgridding module 228, the music synchronization module 232, the overlay and cue module 236, the user performance module 240, the interval audio generation module 244, the social media module 248, the user interface module 252, and the audio library module 256.

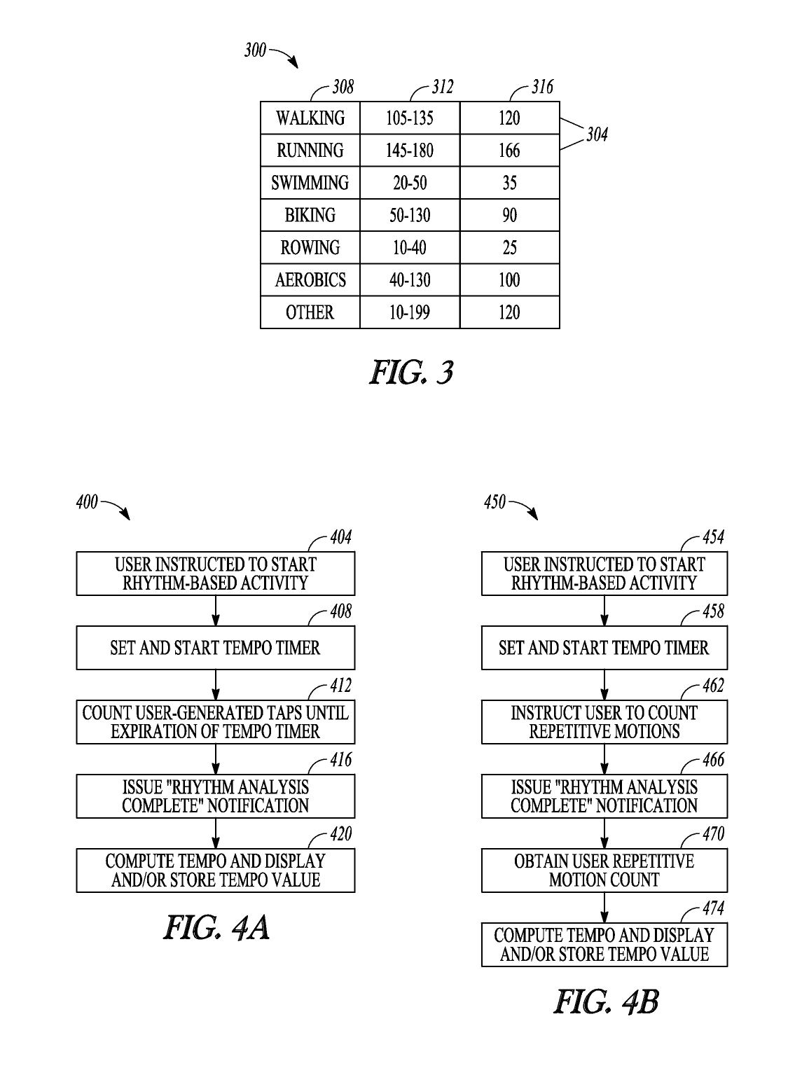

In one example embodiment, the tempo determination module 212 determines a tempo for an activity and/or user, as described in conjunction with FIGS. 3, 4, and 5A-5D. For example, the tempo determination module 212 may determine a tempo based on an activity selected by a user, based on user input that represents a tempo of an activity, and the like.

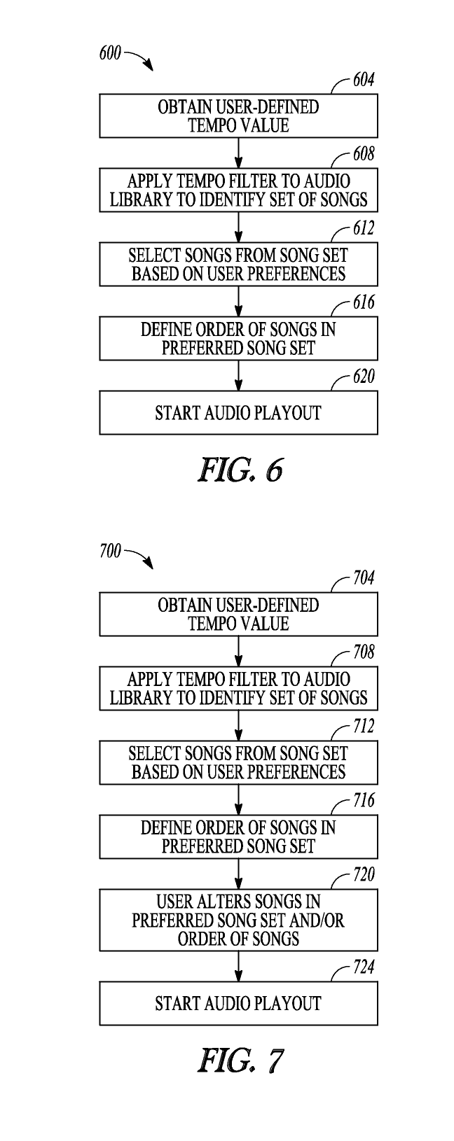

In one example embodiment, the tempo filter module 216 filters songs and other music based on a selected tempo or tempo range, as described in conjunction with FIGS. 6-8. For example, the tempo filter module 216 may identify songs in the audio library 130 that have a tempo that matches a user-selected tempo or tempo range.

In one example embodiment, the recommendation module 220 selects songs based on the preferences of a user, as described in conjunction with FIGS. 6-8 and 20. For example, the recommendation module 220 may select songs based on a user's preferred songs, artists, moods, genres, and the like.

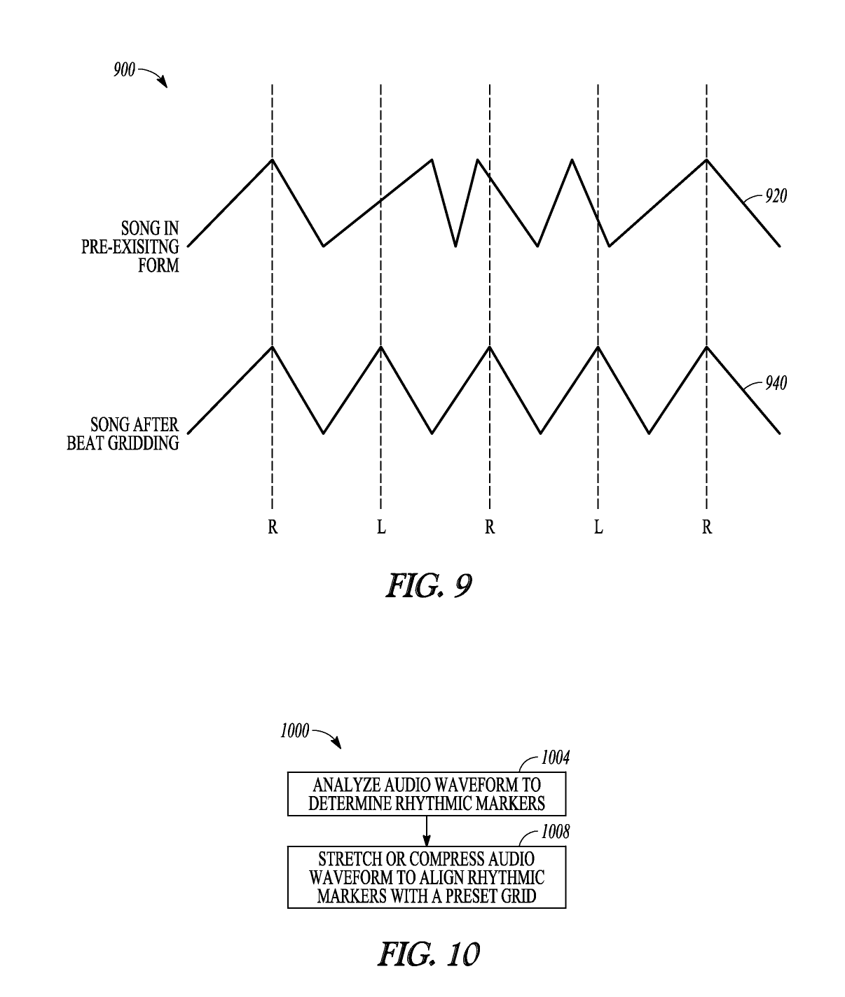

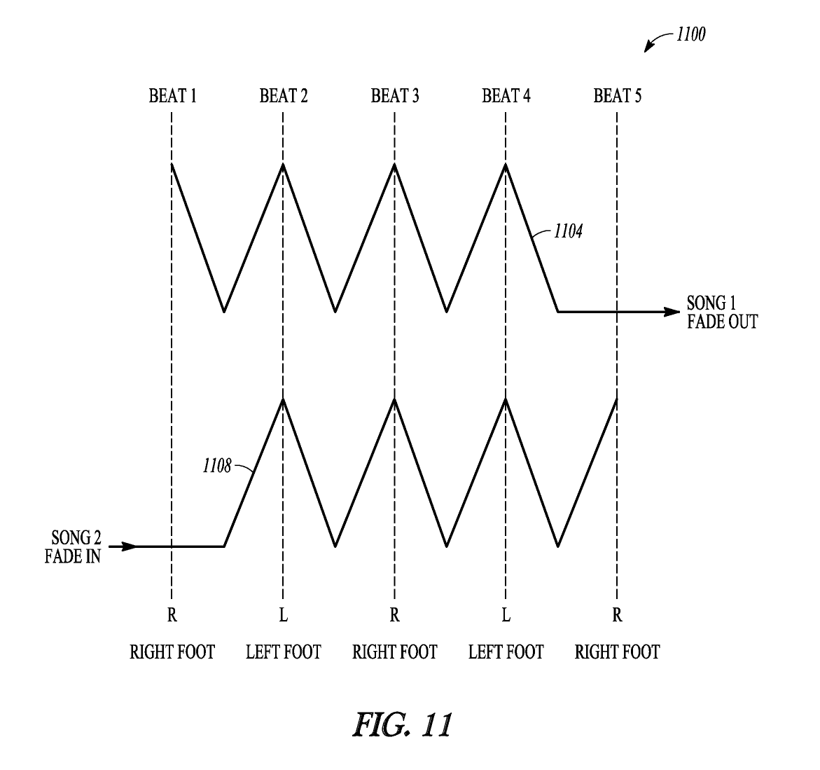

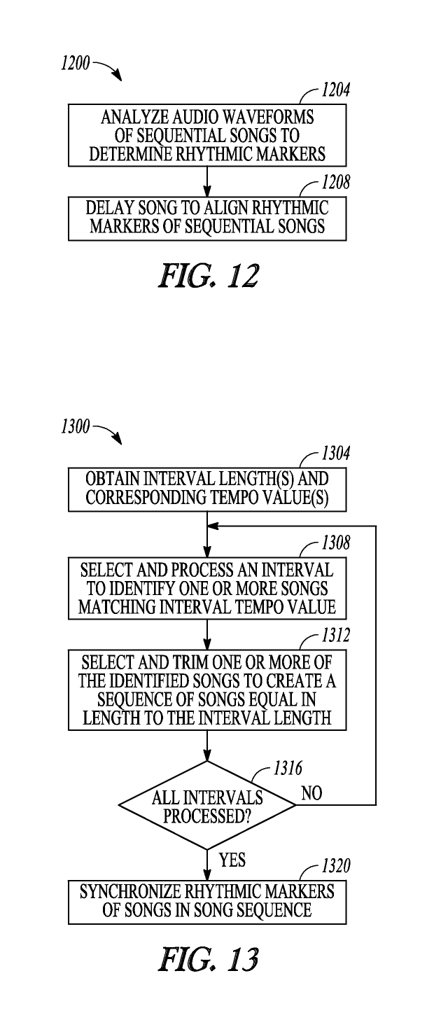

In one example embodiment, the music tempo adjustment module 224 is configured to adjust a tempo of a song or a portion of a song, as described in conjunction with FIG. 10. For example, the music tempo adjustment module 224 may adjust the tempo of a song to be slower or faster than the music's original tempo in order to, for example, match a desired tempo of an activity. In one example embodiment, the beatgridding module 228 is configured to provide songs from the audio library 130 for beatgridding by a beatgridding system. The beatgridding system adjusts portions of a song to match a beatgrid and thereby have a stable tempo, as described in conjunction with FIGS. 9 and 10. In one example embodiment, the music synchronization module 232 is configured to synchronize the beats of sequential songs, as described in conjunction with FIGS. 11 and 12. For example, a second song in a sequence of songs may be delayed such that the beats of the second song are synchronized with the beats of the preceding song.

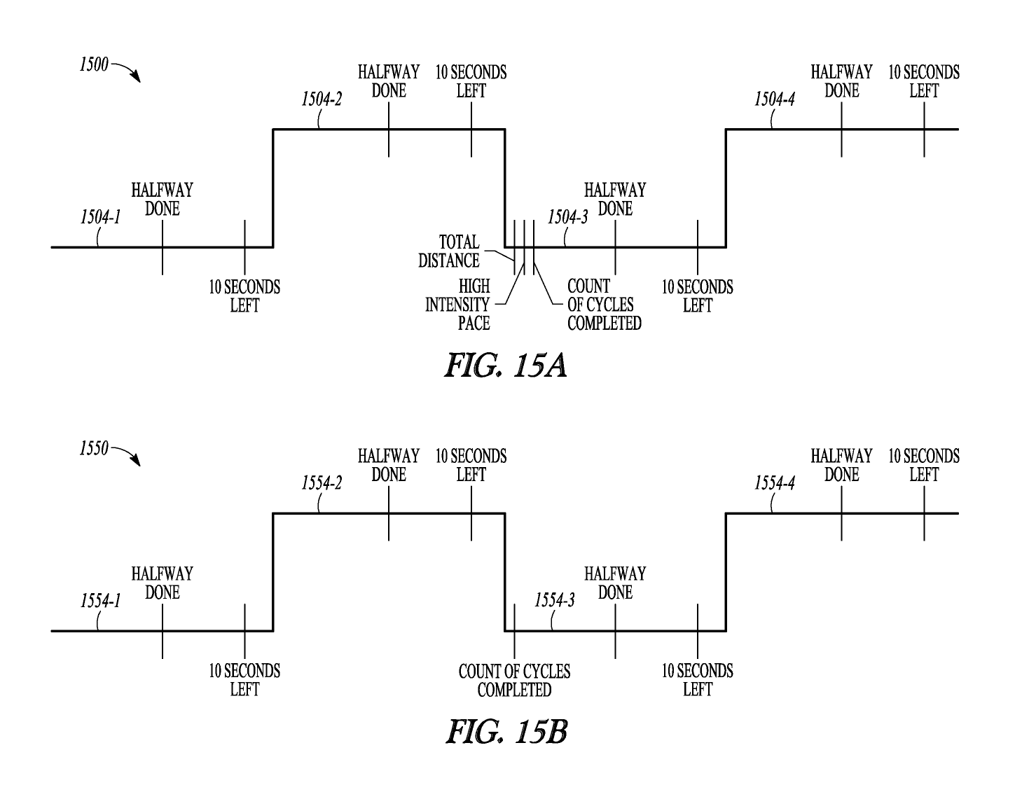

In one example embodiment, the overlay and cue module 236 generates and overlays coaching tools and/or audio cues on the audiotrack. The audio cues may be speech or other types of sound. For example, the overlay and cue module 236 may overlay activity instructions, inspirational messages, rhythm-assistance tools, performance indicators, and the like, as described in conjunction with FIGS. 15A, 15B, 16A, 16B, and 17-19.

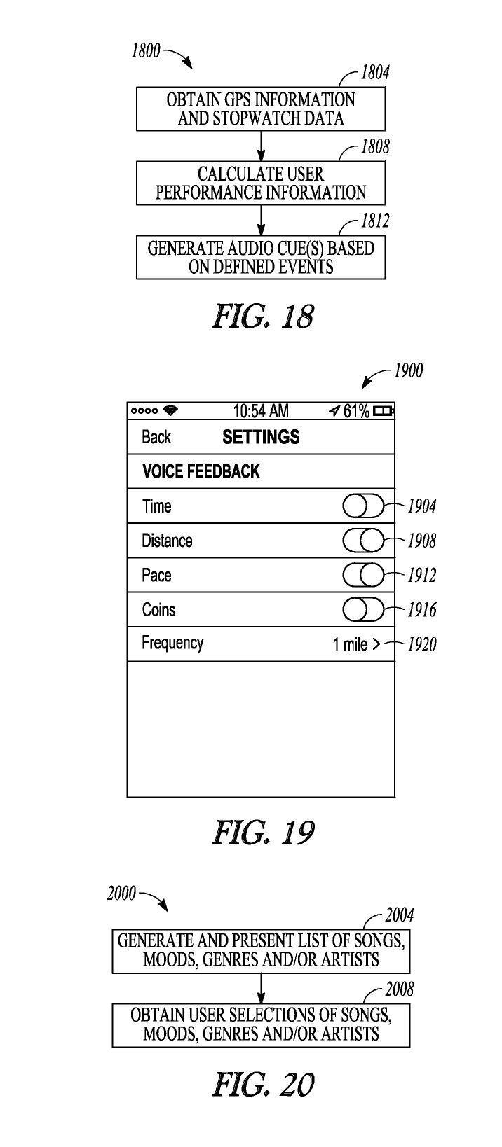

In one example embodiment, the user performance module 240 generates performance information for a user, as described in conjunction with FIGS. 18 and 19. For example, the user performance module 240 may generate statistics such as pace, split pace, distance traveled, elapsed time, calories burned, and the like.

In one example embodiment, the interval audio generation module 244 generates a soundtrack having a tempo that varies in accordance with defined activity intervals, as described in conjunction with FIGS. 13, 14A, 14B, 15A, 15B, 16A, and 16B. For example, the interval audio generation module 244 may obtain the definition of a series of time-based or distance-based intervals and may generate an audio track(s) comprising songs that match the tempo of each interval.

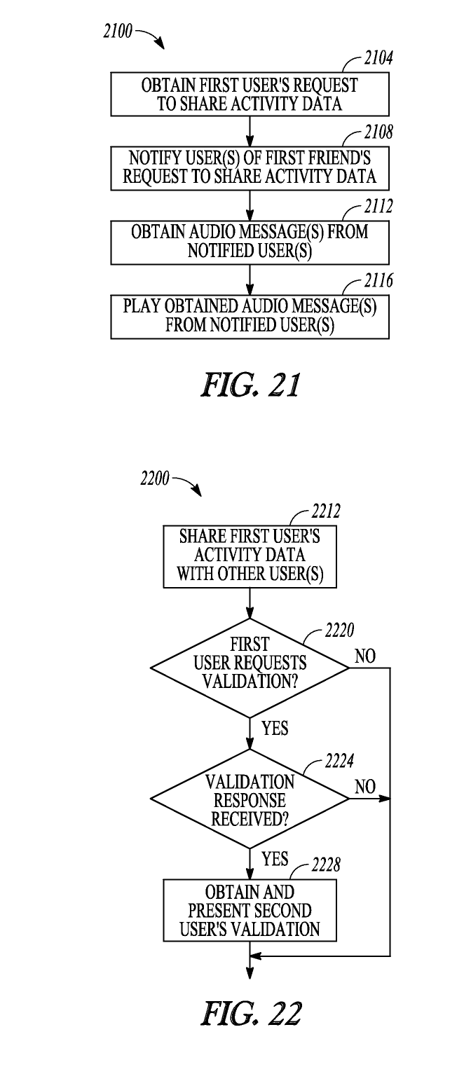

In one example embodiment, the social media module 248 enables a user to have other users, such as family, friends, colleagues, and the like, participate in the user's activity, as described in conjunction with FIGS. 21 and 22. For example, other users may be invited to submit inspirational voice messages to be played for the user while the user is performing the activity, such as running a race.

In one example embodiment, the user interface module 252 enables a user to submit musical preferences, to define intervals for interval-based activities, to hear an audio track(s) designed to accompany one or more activities, to receive user performance information, and the like. In one example embodiment, the audio library module 256 maintains a library of, for example, audio tracks, such as music, songs, audio messages, audio instructions, audio cues, and the like. The audio library module 256 may also provide an interface to the audio library 130.

### Automatic Tempo Selection

In one example embodiment, a rhythmically synchronous audio/behavior experience is created for a user by first determining a desired tempo for the user. For example, a user may select an activity type (e.g., walking, running, and the like) and fitness level (e.g., slow, medium, fast, and the like) and a default tempo value may be determined.

FIG. 3 shows an example tempo table 300 for determining a default tempo value, in accordance with an example embodiment. In one example embodiment, the default tempo value is determined by performing a table lookup of the activity in the tempo table 300. Each row 304 of the tempo table 300 corresponds to a particular activity. Column 308 comprises the activity type for the corresponding row 304, column 312 comprises the default tempo value range for the corresponding activity type, and column 316 comprises the default tempo value for the corresponding activity type. In one example embodiment, additional information, such as a user's physical height, may be incorporated into the tempo table 300 to further refine the default tempo value. For example, a column may be added that corresponds to a user's physical height and a default tempo value may be defined for each combination of activity and user height.

### User-Specified Tempo

In one example embodiment, a user may explicitly input a desired tempo value. For example, the user may enter a specific tempo, such as 120 beats per minute, or tempo range, such as 115 to 125 beats per minute. In one example embodiment, a rhythm analysis may be conducted to determine a personal physical tempo of a particular user. The determined personal physical tempo may be used as the default tempo value of an audio session. The rhythm analysis may comprise a user, for example, tapping a touchscreen or other device for each step, revolution, stroke, or single repetition of a movement taken by the user. The analysis may be conducted for a short test duration, such as ten seconds. For example, a jogger may tap the touchscreen synchronously with each step taken. A count of the taps occurring during the test duration may be computed and the count may be processed to determine a tempo in, for example, repetitions per minute. In one example embodiment, a motion detection mechanism, a gyroscopic mechanism, and/or an accelerometer mechanism of, for example, a smart phone or smart watch may detect and count the repetitive movements of a user, or may provide data for the determination of the repetitive movements of a user.

FIG. 4A is a flowchart of an first example method 400 for determining a user's tempo, in accordance with an example embodiment. One or more of the operations of the method 400 may be performed by the tempo determination module 212. In one example embodiment, the user is instructed to start the repetitive, rhythm-based activity (operation 404). The user begins the repetitive, rhythm-based activity and taps on, for example, a touchscreen in step with the activity. A tempo timer is set to a predefined time, such as fifteen seconds, and the tempo timer is started (operation 408). Once the timer is started, a count of taps is commenced (operation 412). Upon expiration of the timer, the counting of taps is halted and a notification is issued to the user indicating that the analysis period is over (operation 416). The user's tempo is then computed based on the tap count and is displayed to the user and/or stored for future use (operation 420).

FIG. 4B is a flowchart of a second example method 450 for determining a user's tempo, in accordance with an example embodiment. One or more of the operations of the method 450 may be performed by the tempo determination module 212. In one example embodiment, the user is instructed to start the repetitive, rhythm-based activity (operation 454). A tempo timer is set to a predefined time, such as fifteen seconds, and the tempo timer is started (operation 458). The user is instructed to count the repetitive motions of an activity (operation 462). Upon expiration of the tempo timer, a notification is issued to the user indicating that the analysis period is over (operation 466) and the user's repetitive motion count is obtained (operation 470). The user's tempo is then computed based on the obtained repetitive motion count and is displayed to the user and/or stored for future use (operation 474).

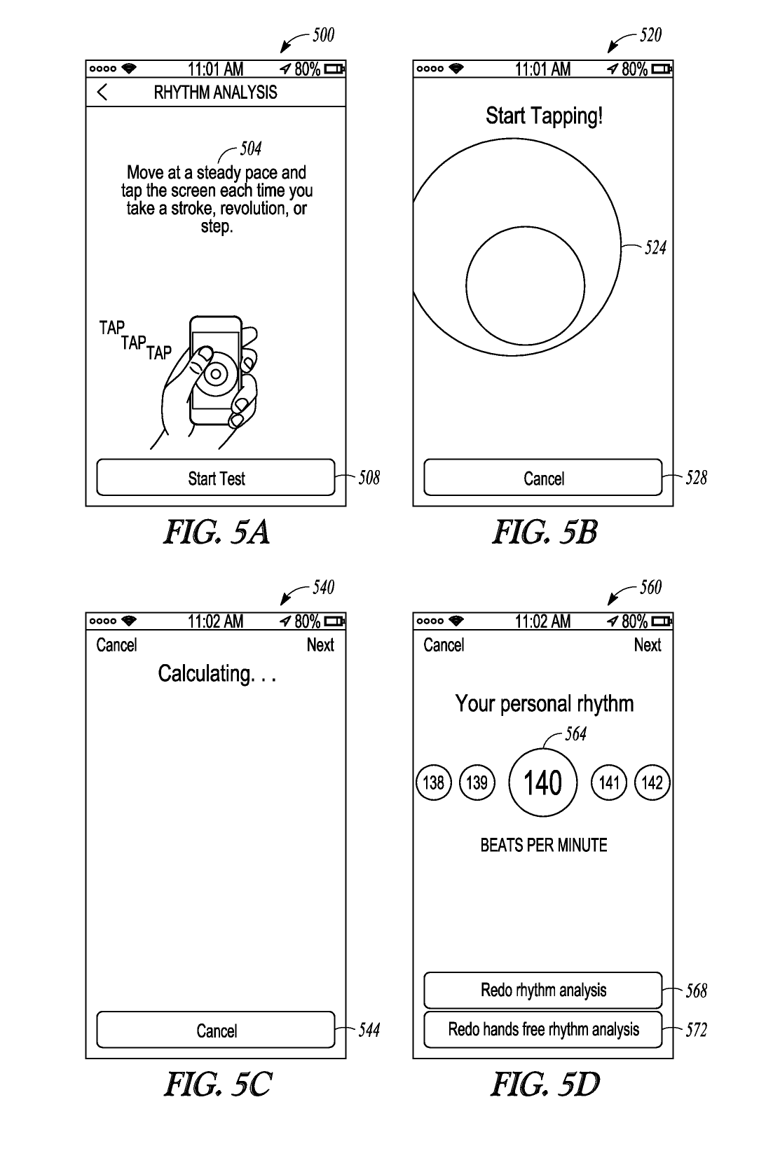

FIGS. 5A-5D illustrate an example user interface 500 for determining a user's tempo, in accordance with an example embodiment. The user interface 500 is generated by the user interface module 252. FIG. 5A illustrates an introduction screenshot for the user interface 500 and comprises instructions 504 and a start test button 508. Selecting the start test button 508 will trigger the start of the method 400 of FIG. 4. FIG. 5B illustrates a tapping screenshot 520 for the user interface 500 and includes a cancel button 528. The user may tap on the tapping area 524 and the tempo determination module 212 will count the taps during the analysis period. Selecting the cancel button 528 will cancel the rhythm analysis.

FIG. 5C illustrates a tempo calculating screenshot 540 for the user interface 500 and includes a cancel button 544. The calculating screenshot 540 is displayed upon expiration of the tempo timer and during calculation of the user's tempo. Selecting the cancel button 544 will cancel the rhythm analysis. FIG. 5D illustrates a tempo display screenshot 560 for the user interface 500 and comprises an indication of the calculated tempo 564, a redo rhythm analysis button 568, and a redo hands-free rhythm analysis button 572. The tempo display screenshot 560 is displayed upon completion of the tempo calculation. Selecting the redo rhythm analysis button 568 will restart the rhythm analysis of method 400 and selecting the redo hands-free rhythm analysis button 572 will restart the rhythm analysis of method 450.

### Audio Experience Generation

FIG. 6 is a flowchart of a first example method 600 for generating an audio session, in accordance with an example embodiment. One or more of the operations of the method 600 may be performed, for example, by the audio generation module 208, the tempo filter module 216, and the recommendation module 220. An audio session may comprise one or more audio tracks. An audio session may be generated and rendered on-the-fly or may be stored and rendered in the future. An audio track comprising songs may be generated as a playlist of songs (or song set), may be directly generated as a track of audio, and the like.

In one example embodiment, a desired tempo value, such as 120 beats per minute, is obtained from a user (operation 604). A tempo filter is then applied to the audio library 130 to identify, for example, one or more songs that fall within a defined range of the desired tempo value (operation 608). The defined range may be, for example, the desired tempo value plus or minus three beats per minute. In one example embodiment, a song recommendation engine may select one or more songs from the set of identified songs that fall within the desired tempo range (operation 612). The song recommendation engine may, for example, select songs based on their popularity with a selected user or a set of users; based on a set of user preferences, such as preferred genre(s), artist(s), songs, and mood(s); and the like. The selected songs may then be arranged in a specific order based on their genre, may be arranged in a random order, and the like (operation 616). The resulting playlist may then be started (operation 620). The playlist may be started immediately, may be started upon the command of a user, or may be automatically started at a latter time.

### Musical Preferences

FIG. 7 is a flowchart of a second example method 700 for generating an audio session, in accordance with an example embodiment. One or more of the operations of the method 700 may be performed, for example, by the audio generation module 208, the tempo filter module 216, and the recommendation module 220. In one example embodiment, a desired tempo value, such as 120 beats per minute, is obtained (operation 704). A tempo filter is then applied to the audio library 130 to identify one or more songs that fall within a defined range of the desired tempo value (operation 708). The defined range may be, for example, the desired tempo value plus or minus five beats per minute. In one example embodiment, a song recommendation engine may select one or more songs from the set of identified songs that fall within the desired tempo range (operation 712). The song recommendation engine may, for example, select songs based on their popularity with a selected user or a set of users, based on a set of user preferences, and the like. The selected songs may then be arranged in a specific order based on genre, may be arranged in a random order, and the like (operation 716). In one example embodiment, the user may rearrange the order of the songs, may add one or more songs to the playlist, and/or remove one or more songs from the playlist (operation 720). The resulting playlist may then be started (operation 724). The playlist may be started immediately, may be started upon the command of a user, or may be automatically started at a latter time.

### Tempo Manipulation

In order to maximize a potential song pool for a selected tempo or cadence, the tempo of a song may be adjusted. This effect is referred to as time stretching. The tempo may be adjusted in a way that does not affect the pitch or key of the music. The time stretching technique may be automatically performed, may be activated by the user, or both. The time stretching may be performed offline and the resulting song may be stored in the audio library for future use, or the time stretching may be performed on-the-fly as the audio track(s) is being played. In one example embodiment, the timestretching technique may be performed by the Dirac Time Stretching product manufactured by the DSP Dimension Co. of Germany.

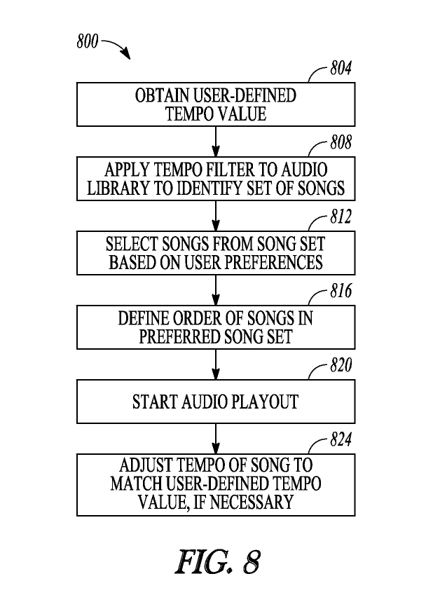

FIG. 8 is a flowchart of a third example method 800 for generating an audio session, in accordance with an example embodiment. One or more of the operations of the method 800 may be performed, for example, by the audio generation module 208, the tempo filter module 216, the recommendation module 220, and the music tempo adjustment module 224. In one example embodiment, a desired tempo value, such as 120 beats per minute, is obtained (operation 804). A tempo filter is then applied to the audio library 130 to identify one or more songs that fall within a defined range of the desired tempo value (operation 808). The defined range may be, for example, the desired tempo value plus or minus ten beats per minute. In one example embodiment, a song recommendation engine may select one or more songs from the set of identified songs that fall within the desired tempo range (operation 812). The selected songs may then be arranged in a specific order based on genre, may be arranged in a random order, and the like (operation 816). The resulting playlist may then be started (operation 820). The playlist may be started immediately, may be started upon the command of a user, or may be started at a latter time. As each song is played, the tempo of the song is adjusted to match the desired tempo submitted by the user (operation 824). In one example embodiment, the user may also manually adjust the tempo of a song as it is being played.

### Beatgridding

The tempo of some songs may change during the course of the song due to stylistic choices, imprecise performances, and the like. In some situations, it is desirable to vary the tempo of a song, such as when a jogger desires to vary his or her speed. In other situations, when a user seeks to pair music to a rhythmically repetitive behavior, such as walking or jogging at a fixed speed, it may be desirable for the beat or pulse of the music to remain as close as possible to a fixed grid or meter. For example, if a jogger is attempting to synchronize footsteps with the beat of a song, it may be important that each downbeat remains in time with the other beats around it. In one example embodiment, portions of a song may be automatically re-shifted to fit a rhythmic grid. This effect is known as beatgridding. FIG. 9 shows the tempo 900 of a micro portion of a song before re-shifting 920 and after re-shifting 940, in accordance with an example embodiment. As illustrated, the re-shifted song is characterized by a relatively stable tempo. The beatgridding module 228 is configured to 228 to provide songs from the audio library 130 for beatgridding. The beatgridding may be performed by, for example, the Ableton Live product line manufactured by the Ableton Co. of Berlin, Germany.

FIG. 10 is a flowchart of an example method 1000 for re-shifting portions of a song, in accordance with an example embodiment. In one example embodiment, the amplitude and frequency of an audio waveform are analyzed to determine the location of a song's rhythm markers (such as the peaks and/or valleys of the audio waveform) (operation 1004). Each portion of the audio waveform may then be stretched or compressed so that the rhythm markers (peaks and valleys of the audio waveform) line up with a preset grid (operation 1008). In one example embodiment, the preset grid corresponds to an assigned tempo.

### Seamless Audio Transition

In one example embodiment, in order to maintain a smooth pace from one song to the next, the beats at the beginning of the next song in a sequence of songs may be synchronized, or temporally lined up, with the beats of the previous song in the sequence of songs to create a seamless transition between the songs. FIG. 11 illustrates the tempo 1100 of two songs 1104, 1108 that that have been synchronized, in accordance with an example embodiment. As illustrated in FIG. 11, the peaks of each waveform correspond to the beats of each song.

FIG. 12 is a flowchart of an example method 1200 for synchronizing the beats of two sequential songs, in accordance with an example embodiment. One or more of the operations of the method 1200 may be performed, for example, by the music synchronization module 232. In one example embodiment, the amplitude and frequency of an audio waveform of both songs are analyzed to determine the location of the songs' rhythm markers (operation 1204). One of the songs is then delayed such that the songs' rhythm markers are aligned (operation 1208).

### Interval-Based Audio Sessions

In some instances, an activity may change tempo over a single session. For example, a runner may warm up at a slow pace, run at alternating moderate and fast paces, and then cool down at a slow pace. In one example embodiment, a portion of a song, an entire song, a plurality of songs, and/or a combination of the above may be selected for each interval of the activity, where the selected songs match the tempo of the activity during the time period of the corresponding interval.

FIG. 13 is a flowchart of an example method 1300 for creating an interval-based audio session, in accordance with an example embodiment. One or more of the operations of the method 1300 may be performed, for example, by the interval audio generation module 244. In one example embodiment, method 1300 is performed prior to the start of an audio session. In one example embodiment, operations 1308-1320 of method 1300 are performed on-the-fly where, for example, the trimming of the length of a song to match the total time length of the interval is performed as the song is played.

In one example embodiment, a definition for each of a plurality of intervals for an audio session, including interval time length and a corresponding tempo value, are obtained (operation 1304). For example, a user may enter a list of intervals comprising the time length and tempo value of each interval or may select from a set of predefined interval lists. An interval time length and a corresponding tempo value are then selected from the list and processed to identify one or more songs in, for example, the audio library 130 that correspond to the specified tempo value (operation 1308). One or more of the songs may be trimmed in length such that the total length of the songs identified for the interval equal the time length of the interval (operation 1312). A test is then performed to determine if all of the intervals have been processed (operation 1316). If all of the intervals have not been processed, the method 1300 proceeds with operation 1308; otherwise, the sequence of identified songs may optionally be processed using the techniques of method 1200 for synchronizing the beats of sequential songs (operation 1320). The method 1300 may then end.

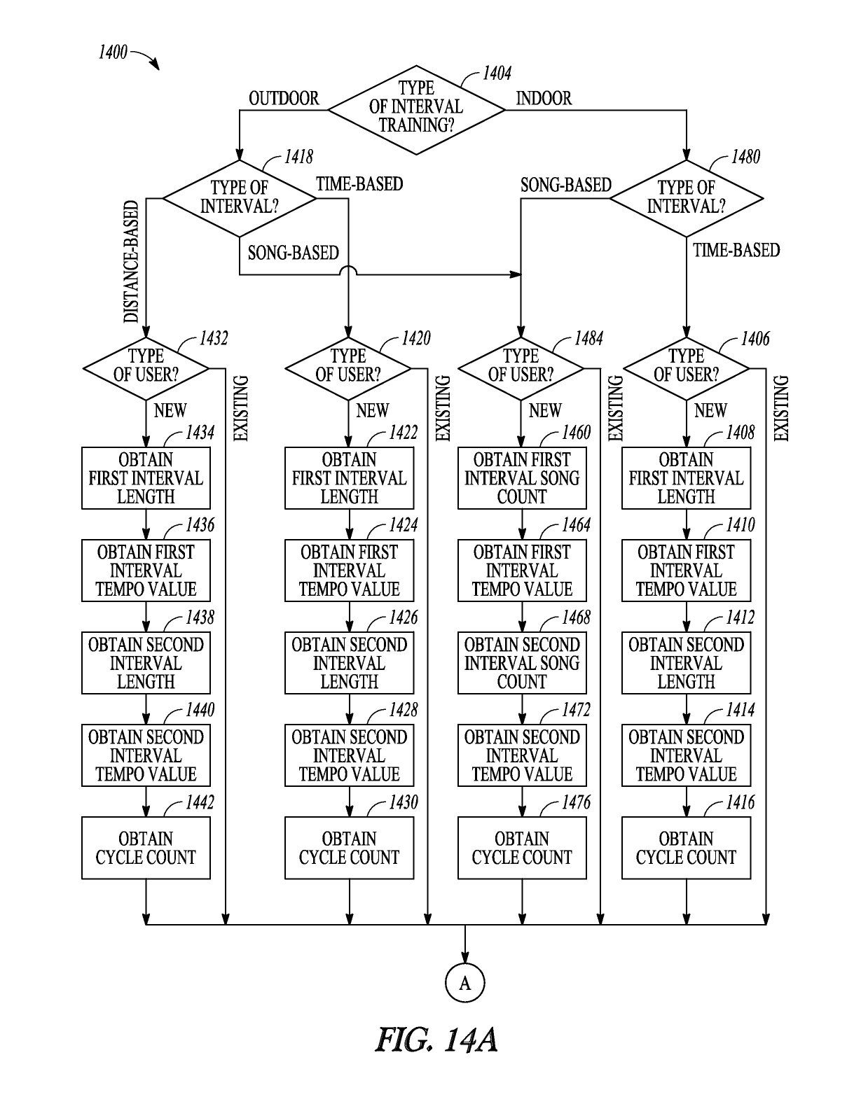

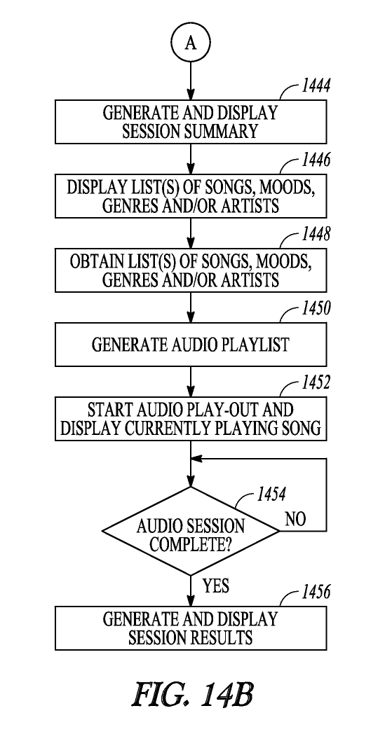

FIGS. 14A and 14B illustrate an example workflow 1400 for interacting with an example interval-based audio session, in accordance with an example embodiment. As illustrated in FIG. 14A, in one example embodiment, a type of interval training session, such as an indoor interval training session or an outdoor interval training session, is selected (operation 1404). If an outdoor interval training session is selected, the method 1400 proceeds with operation 1418. If an indoor interval training session is selected, a type of interval, such as time-based intervals or song-based intervals, is obtained (operation 1480). If song-based intervals are selected, the method 1400 proceeds with operation 1484. If time-based intervals are selected, a determination is made whether the user is a new user or an existing user (operation 1406). If the user is a new user, the method 1400 proceeds with operation 1408; otherwise, the method 1400 proceeds with operation 1444 (shown in FIG. 14B).

During operation 1408, the time length for, for example, a low intensity interval is obtained. A tempo value for the low intensity interval is also obtained (operation 1410). Similarly, a time length for, for example, a high intensity interval is obtained (operation 1412) and a tempo value for the high intensity interval is obtained (operation 1414). A count of low intensity/high intensity cycles is also obtained (operation 1416). The count of low intensity/high intensity cycles indicates the number of low intensity/high intensity cycles to be included in the audio session.

During operation 1418, a type of interval, such as time-based intervals, song-based intervals, or distance-based intervals, is obtained. If distance-based intervals are selected, the method 1400 proceeds with operation 1432. If song-based intervals are selected, the method 1400 proceeds with operation 1484. If time-based intervals are selected, a determination is made whether the user is a new user or an existing user (operation 1420). If the user is a new user, the method 1400 proceeds with operation 1422; otherwise, the method 1400 proceeds with operation 1444. During operation 1422, a time length for, for example, a low intensity interval is obtained. A tempo value for the low intensity interval is also obtained (operation 1424). Similarly, a time length for, for example, a high intensity interval is obtained (operation 1426) and a tempo value for the high intensity interval is obtained (operation 1428). A count of low intensity/high intensity cycles is also obtained (operation 1430).

During operation 1432, a determination is made whether the user is a new user or an existing user. If the user is a new user, the method 1400 proceeds with operation 1434; otherwise, the method 1400 proceeds with operation 1444. During operation 1434, a distance length for, for example, a low intensity interval is obtained. A tempo value for the low intensity interval is also obtained (operation 1436). Similarly, a distance length for, for example, a high intensity interval is obtained (operation 1438) and a tempo value for the high intensity interval is obtained (operation 1440). A count of low intensity/high intensity cycles is also obtained (operation 1442).

During operation 1484, a determination is made whether the user is a new user or an existing user. If the user is a new user, the method 1400 proceeds with operation 1460; otherwise, the method 1400 proceeds with operation 1444. During operation 1460, a song count of, for example, a low intensity interval is obtained. A tempo value for the low intensity interval is also obtained (operation 1464). Similarly, a song count for, for example, a high intensity interval is obtained (operation 1468) and a tempo value for the high intensity interval is obtained (operation 1472). A count of low intensity/high intensity cycles is also obtained (operation 1476). The count of low intensity/high intensity cycles indicates the number of low intensity/high intensity cycles to be included in the audio session.

During operation 1444, as illustrated in FIG. 14B, a summary of the audio session is generated and presented to the user. For example, the total time and/or total distance of the interval training session may be generated and presented to the user. The user may then be presented with lists of genre(s), artist(s), song(s), mood(s), and the like that may be selected for the audio session (operation 1446) and a selection of one or more of the genre(s), artist(s), song(s), mood(s), and the like for the audio session may be obtained (operation 1448). Based on the user selections, an audio playlist is generated (operation 1450). The audio session may then be started and the identity of, for example, the currently playing song may be displayed to the user (operation 1452). A test is then performed to determine if the play-out of the audio session is complete (operation 1454). Once the play-out of the audio session is complete, summary information on the completed audio session(s) is generated and displayed (operation 1456). In one example embodiment, operations 1406, 1420, 1432 are based on the type of training session and not the type of user. For example, operations 1406, 1420, 1432 may determine whether the interval training session is a new or existing training session and may then proceed as illustrated in FIGS. 14A and 14B.

FIGS. 15A and 15B illustrate sequences 1500 and 1550 of example intervals for an interval-based audio session, in accordance with an example embodiment. As illustrated in FIG. 15A, intervals 1504-1 and 1504-3 are low intensity intervals and intervals 1504-2 and 1504-4 are high intensity intervals. Various audio cues are played at different times during the audio session. For example, “halfway done” audio cues are played halfway through each interval, a “ten seconds left” audio cue is played tens seconds prior to the end of each interval, and “total distance”, “high intensity pace”, and a “count of completed cycles” audio cues are played periodically during the audio session. The “total distance” and “high intensity pace” may be generated with the use of, for example, global positioning satellite (GPS) information on the user.

Similarly, as illustrated in FIG. 15B, intervals 1554-1 and 1554-3 are low intensity intervals and intervals 1554-2 and 1554-4 are high intensity intervals. Various audio cues are played at different times of the audio session. For example, “halfway done” audio cues are played halfway through each interval, a “ten seconds left” audio cue is played tens seconds prior to the end of each interval, and a “count of completed cycles” is played periodically during the audio session. The “total distance” and “high intensity pace” are not calculated in the scenario of FIG. 15B as access to GPS information is not available.

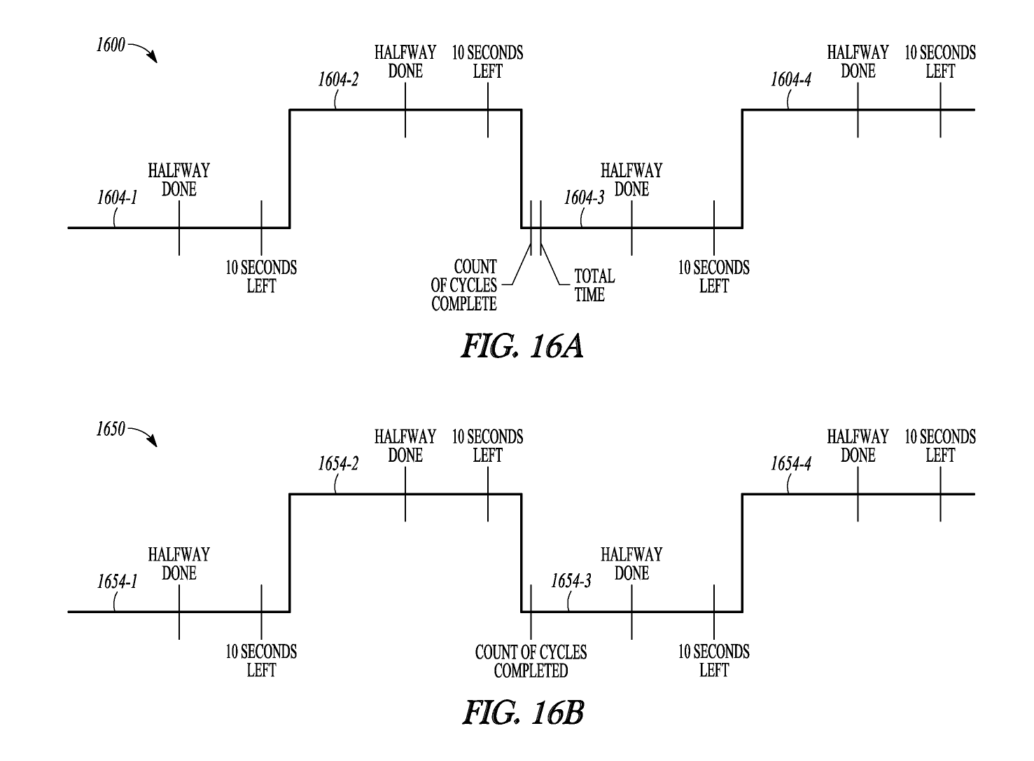

FIGS. 16A and 16B illustrate sequences 1600 and 1650 of example intervals for an interval-based audio session. As illustrated in FIG. 16A, intervals 1604-1 and 1604-3 are low intensity intervals and intervals 1604-2 and 1604-4 are high intensity intervals. Various audio cues are played at different times of the audio session. As described above, “halfway done” audio cues are played halfway through each interval, a “ten seconds left” audio cue is played tens seconds prior to the end of each interval, and a “count of completed cycles” is played periodically during the audio session. Since the session is taking place indoors on a treadmill, the “total distance” and “high intensity pace” are not capable of being calculated as GPS information is not relevant. In one example embodiment, the treadmill or other equipment is configured to send performance information to the apparatus 200. In this case, it may be possible to calculate the “total distance” and “high intensity pace” performance measurements from the obtained performance information.

Similarly, as illustrated in FIG. 16B, intervals 1654-1 and 1654-3 are low intensity intervals and intervals 1654-2 and 1654-4 are high intensity intervals. Various audio cues are played at different times of the audio session. For example, “halfway done” audio cues are played halfway through each interval, a “ten seconds left” audio cue is played tens seconds prior to the end of each interval, and a “count of completed cycles” is played periodically during the audio session. The “total distance” and “high intensity pace” are not calculated in the scenario of FIG. 16B as access to GPS information is not available.

### Overlaid Coaching Tools and Audio Cues

In one example embodiment, activity coaching tools may be overlaid on the audio track(s). Coaching tools may include activity instructions, inspirational messages, rhythm-assistance tools, and the like. For example, an audio coaching tool, such as a metronome, may be overlaid on the audio track(s) to assist a user in finding the beat of a song. In one example embodiment, voice cues may be overlaid on the audio track(s) and may be used to notify the user of, for example, quantitative performance data such as pace, time, distance traveled, calories burned, and the like. The voice cues may be automatically presented intermittently during and/or after an audio session or may be prompted for presentation by the user. For example, a user may press a touch screen, use an in-line headphone device, use built-in voice recognition mechanisms, and the like to prompt the user interface module 252 for the presentation of audio cues.

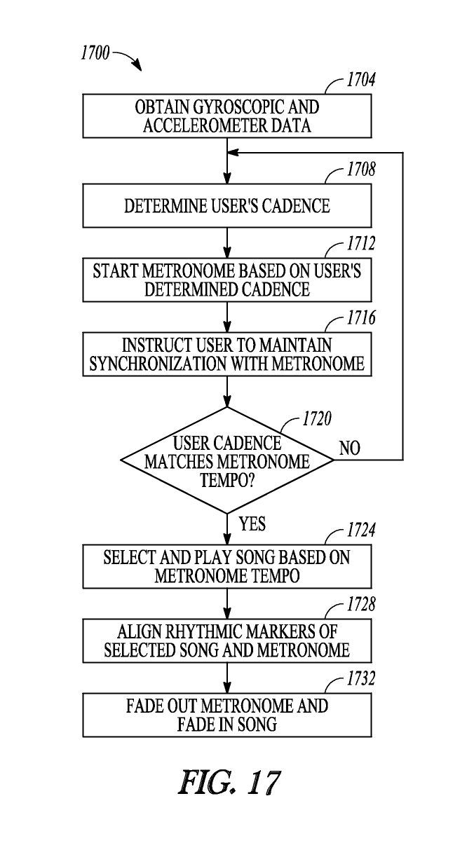

FIG. 17 is a flowchart of an example method 1700 for overlaying a coaching tool, in accordance with an example embodiment. One or more of the operations of the method 1700 may be performed, for example, by the overlay and cue module 236. In one example embodiment, gyroscopic and/or accelerometer data that is reflective of a user's cadence is obtained (operation 1704). For example, gyroscopic and/or accelerometer data may be obtained from, for example, a smartphone, a smart watch, and the like. The user's cadence is then determined based on the gyroscopic and/or accelerometer data (operation 1708) and a metronome is started at a tempo that matches the user's determined cadence (operation 1712). In one example embodiment, the metronome is started at a tempo that matches the user's cadence as determined by one of the techniques disclosed herein.

In one example embodiment, the user is instructed to maintain a cadence in sync with the metronome (operation 1716). A determination may then be made of whether the user is matching the tempo of the metronome (operation 1720). For example, the gyroscopic and/or accelerometer data may be analyzed to determine if the user's cadence matches the tempo of the metronome, or the user may be queried to determine if the user's cadence matches the tempo of the metronome. If the user's cadence does not match the tempo of the metronome, the method 1700 proceeds with operation 1708 and the metronome may be recalibrated; otherwise, a song that matches the tempo of the metronome is selected and played (1724). In one example embodiment, the audio waveform of the music is manipulated such that the beats of the song align with the beats of the metronome (1728). This may be accomplished using, for example, techniques from the song synchronization method 1200. For example, the waveform of the song or the metronome may be delayed such that the beats of the song align with the beats of the metronome. In one example embodiment, the metronome may be faded out as the music is faded in or after the music fades in (operation 1732).

FIG. 18 is a flowchart of an example method 1800 for generating audio cues, in accordance with an example embodiment. One or more of the operations of the method 1800 may be performed, for example, by the overlay and cue module 236. In one example embodiment, global positioning satellite (GPS) information and stopwatch data associated with a user is obtained (operation 1804). The obtained GPS information and stopwatch data is used to calculate, for example, performance information for the user. Performance information may include a location(s) of a user, distance traveled, elapsed time, total pace, split pace, calories burned, and the like (operation 1808). At defined events, such as an arrival of the user at a defined location, an achievement of a distance traveled, an occurrence of a defined elapsed time, and the like, an audio cue may be generated (operation 1812). For example, an audio cue may be generated every five minutes and/or once for every mile traveled. In one example embodiment, a speech cue is generated and overlaid on the audio track(s) playing at the time. In one example embodiment, an audio fade is performed to reduce the volume of the audio track(s) during the playing of the audio cue and to increase the volume of the audio track(s) after the playing of the audio cue. In one example embodiment, the audio cues are “coin attainment” sounds or are accompanied by “coin attainment” sounds, where each “coin attainment” sound corresponds to the attainment of a performance goal, a milestone, and the like.

In one example embodiment, a user may be presented with any number of “coin attainment” sounds upon completion of a milestone, such as completing a one kilometer run, taking 1,000 steps, and the like. During and/or at the end of an audio session, the accumulation of coins may be indicated using various sounds, such as slot machine type sounds. As a user continues to attain new milestones, more “coin attainment” sounds may be generated or “coins” may be accumulated for presentation at a later time. The coin attainment sounds may be based on various sounds, such as slot machine type sounds, and may be shorter in duration than spoken voice cues, thereby potentially offering less distraction from the primary audio experience.

FIG. 19 illustrates an example user interface 1900 for configuring voice feedback, in accordance with an example embodiment. In one example embodiment, the settings for the voice feedback comprise a slider for time-based voice cues 1904, a slider for distance-based voice cues 1908, a slider for pace-based voice cues 1912, and a slider for coin cues 1916. As illustrated in FIG. 19, distance-based and pace-based voice cues are enabled and time-based and coin cues are disabled. In addition, a frequency selector 1920 allows a user to define how often a voice cues is issued. As illustrated in FIG. 19, a voice cue is issued every mile.

### Recommendation Engine

In one example embodiment, a user is able to positively or negatively rate a played song. For example, a user may rate a song with a like or dislike, with a ratings scale (such as 1-4 stars), and the like to create a user song profile. Ratings may be stored for future use in recommending songs for an audio session. A positive rating will increase a song's likelihood of selection and a negative rating will decrease or eliminate a song's likelihood of selection. In one example embodiment, song ratings from other users with similar musical taste profiles may be aggregated in order to refine future song recommendations.

FIG. 20 is a flowchart of an example method 2000 for rating songs, in accordance with an example embodiment. One or more of the operations of the method 2000 may be performed, for example, by the user interface module 252. In one example embodiment, a list of genres, artists, songs, moods, and the like may be generated and presented to a user (operation 2004). A user's selection(s) of the genres, artists, songs, moods, and the like may then be obtained (operation 2008) and stored for future use.

In one example embodiment, highly rated songs from other sources, such as external websites, may be utilized to discover additional songs with similar musical and harmonic qualities (including beat intensity, key, mood, and the like). The newly discovered songs may be pooled in the audio library 130 with similar existing songs.

### Voice Control

Many rhythm-based activities such as jogging, biking, and aerobic exercise demand significant movement and visual attention. In one example embodiment, a voice control feature may be utilized to convey commands associated with the audio experience to the user interface module 252. Voice commands may be recognized by a microphone or other device which may be located within a mobile phone, attached to an in-line headphone device, and the like. Voice commands may include commands to change tempo, skip a song, pause a song, change audio volume, end an audio session, and the like.

### Social Media Enhancements

In one example embodiment, audio cues may be presented in the form of real-time voice messages. At the start of a session, a user may have the option to share their activity with other users, such as friends, family, colleagues, and the like. An email or electronic message may then be sent to a preselected group of users. For example, an electronic message may read: “Your friend Matt is about to go for a run. Send him a message to cheer him on!” The message recipient has the option of recording an audio or text-based message. If the recipient chooses to record a message, the message will be automatically sent back to the device of the originating user. The recipient has the option to open and play the message immediately or save the message and play it at a latter time. In one example embodiment, the message is automatically played for the user prior to, during or after the audio session. For example, the message may be played just prior to or after attaining a performance goal or milestone.

FIG. 21 is a flowchart of a first example method 2100 for integrating social media with an audio session, in accordance with an example embodiment. One or more of the operations of the method 2100 may be performed, for example, by the social media module 248. In one example embodiment, a request to share activity data is obtained from a first user (operation 2104) and a notification of the first user's request to share activity data is issued to friends, supporters, and/or other users (operation 2108). Each notified user may then record an audio message, such as a message to cheer on the first user, and the message may be obtained (operation 2112). Each recorded message may then be automatically played for the first user (operation 2116). For example, each message may be played at a random time prior to, during, or subsequent to the activity; at one of a plurality of predefined times; at an attainment of a particular milestone or goal; and the like.

FIG. 22 is a flowchart of a second example method 2200 for integrating social media with an audio session, in accordance with an example embodiment. One or more of the operations of the method 2200 may be performed, for example, by the social media module 248. In one example embodiment, a first user's activity data is shared with another user(s) (operation 2212). For example, a user's running goal may be shared with a second user. Upon completion of the activity and/or attainment of a goal, the first user can request a validation, such as a text message, a cartoon, an audio snippet, and the like, from the other user(s). A test is therefore performed to determine if the first user has requested validation (operation 2220). If the first user has not requested validation, the method 2200 may end; otherwise, a test is performed to determine if the other user(s), such as a friend of the first user, has sent a validation to the first user (operation 2224). If the other user has not sent a validation, the method 2200 may end; otherwise, the validation from the other user(s) is obtained and presented to the first user (operation 2228).

Although certain examples are shown and described here, other variations exist and are within the scope of the invention. It will be appreciated, by those of ordinary skill in the art, that any arrangement, which is designed or arranged to achieve the same purpose, may be substituted for the specific embodiments shown. This application is intended to cover any adaptations or variations of the example embodiments of the invention described herein. It is intended that this invention be limited only by the claims, and the full scope of equivalents thereof.

### Example Mobile Device

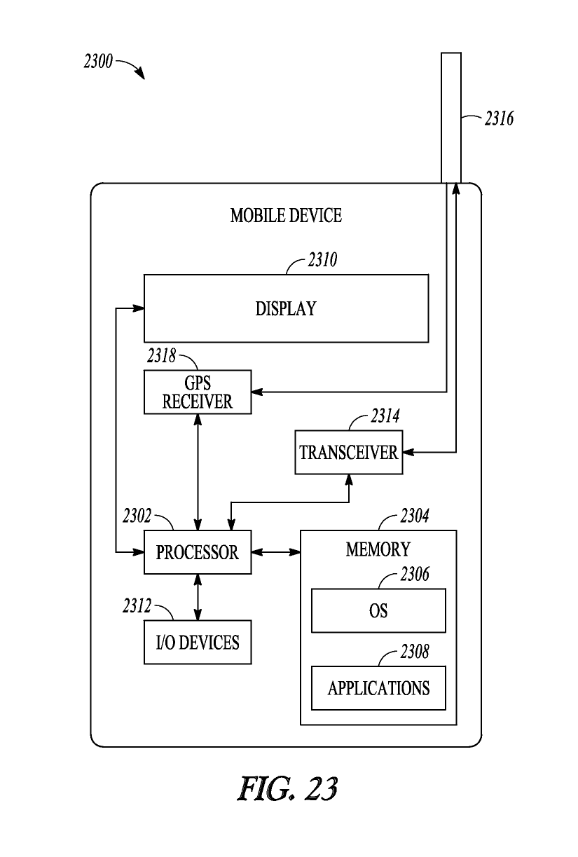

FIG. 23 is a block diagram illustrating an example mobile device 2300, according to an example embodiment. The mobile device 2300 may include a processor 2302. The processor 2302 may be any of a variety of different types of commercially available processors suitable for mobile devices (for example, an XScale architecture microprocessor, a microprocessor without interlocked pipeline stages (MIPS) architecture processor, or another type of processor 2302). A memory 2304, such as a random access memory (RAM), a flash memory, or other type of memory, is typically accessible to the processor 2302. The memory 2304 may be adapted to store an operating system (OS) 2306, as well as application programs 2308, such as a mobile location enabled application that may provide LBSs to a user. The processor 2302 may be coupled, either directly or via appropriate intermediary hardware, to a display 2310 and to one or more input/output (I/O) devices 2312, such as a keypad, a touch panel sensor, a microphone, and the like. Similarly, in some embodiments, the processor 2302 may be coupled to a transceiver 2314 that interfaces with an antenna 2316. The transceiver 2314 may be configured to both transmit and receive cellular network signals, wireless data signals, or other types of signals via the antenna 2316, depending on the nature of the mobile device 2300. Further, in some configurations, a GPS receiver 2318 may also make use of the antenna 2316 to receive GPS signals.

### Modules, Components, and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiples of such hardware-implemented modules exist contemporaneously, communications may be achieved through signal transmission (e.g., over appropriate circuits and buses that connect the hardware-implemented modules). In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

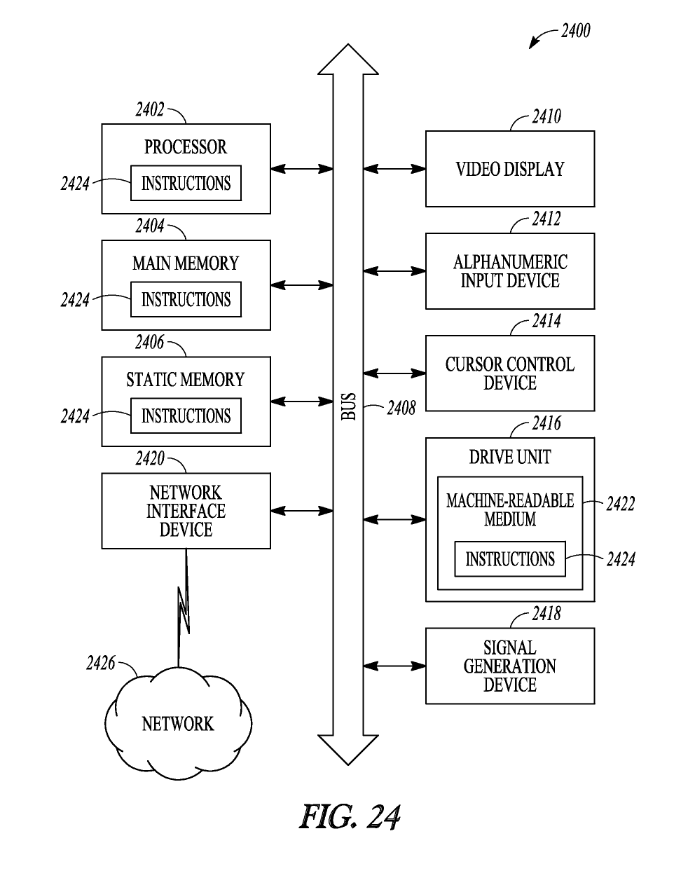

FIG. 24 is a block diagram of a machine within which instructions may be executed for causing the machine to perform any one or more of the methodologies discussed herein. In one example embodiment, the machine may be the example apparatus 200 of FIG. 2 for generating an audio experience. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 2400 includes a processor 2402 (e.g., a central processing unit (CPU), a graphics processing unit (GPU) or both), a main memory 2404 and a static memory 2406, which communicate with each other via a bus 2408. The computer system 2400 may further include a video display unit 2410 (e.g., a liquid crystal display (LCD) or a cathode ray tube (CRT)). The computer system 2400 also includes an alphanumeric input device 2412 (e.g., a keyboard), a user interface (UI) navigation (or cursor control) device 2414 (e.g., a mouse), a disk drive unit 2416, a signal generation device 2418 (e.g., a speaker) and a network interface device 2420.

### Machine-Readable Medium

The drive unit 2416 includes a machine-readable medium 2422 on which is stored one or more sets of data structures and instructions 2424 (e.g., software) embodying or utilized by any one or more of the methodologies or functions described herein. The instructions 2424 may also reside, completely or at least partially, within the main memory 2404 and/or within the processor 2402 during execution thereof by the computer system 2400, the main memory 2404 and the processor 2402 also constituting machine-readable media 2422. Instructions 2424 may also reside within the static memory 2406.

While the machine-readable medium 2422 is shown in an example embodiment to be a single medium, the term “machine-readable medium” may include a single medium or multiple media (e.g., a centralized or distributed database, and/or associated caches and servers) that store the one or more data structures or instructions 2424. The term “machine-readable medium” shall also be taken to include any tangible medium that is capable of storing, encoding or carrying instructions 2424 for execution by the machine and that cause the machine to perform any one or more of the methodologies of the present invention, or that is capable of storing, encoding or carrying data structures utilized by or associated with such instructions 2424. The term “machine-readable medium” shall accordingly be taken to include, but not be limited to, solid-state memories, and optical and magnetic media. Specific examples of machine-readable media 2422 include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and CD-ROM and DVD-ROM disks.

### Transmission Medium

The instructions 2424 may further be transmitted or received over a communications network 2426 using a transmission medium. The instructions 2424 may be transmitted using the network interface device 2420 and any one of a number of well-known transfer protocols (e.g., hypertext transfer protocol (HTTP)). Examples of communications networks 2426 include a local area network (“LAN”), a wide area network (“WAN”), the Internet, mobile telephone networks, plain old telephone (POTS) networks, and wireless data networks (e.g., WiFi and WiMax networks). The term “transmission medium” shall be taken to include any intangible medium that is capable of storing, encoding or carrying instructions 2424 for execution by the machine, and includes digital or analog communications signals or other intangible media to facilitate communication of such instructions 2424.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A system for generating an audio experience, the system comprising:
a tempo determination module, implemented with one or more hardware devices, for obtaining a tempo value of an activity;
a tempo filter module for identifying one or more songs characterized by a tempo that matches the obtained tempo value; and
an audio generation module for generating a playlist of songs that match the obtained tempo value.

2. The system of claim 1, further comprising a tempo table for determining a tempo value corresponding to a defined activity.

3. The system of claim 1, wherein the tempo determination module determines the tempo based on physical movements of a user.

4. The system of claim 1, further comprising a recommendation module for selecting songs that are characterized by the tempo that matches the obtained tempo value and that are consistent with one or more user preferences.

5. The system of claim 1, further comprising a music tempo adjustment module for adjusting a tempo of a song.

6. The system of claim 1, further comprising a beatgridding module for adjusting a tempo of one or more portions of a song to match a rhythmic grid.

7. The system of claim 1, further comprising a music synchronization module to synchronize beats of two or more sequential songs.

8. The system of claim 1, further comprising an interval audio generation module for generating a playlist of songs that conforms to a plurality of intervals, each interval characterized by a defined length and a tempo.

9. The system of claim 8, wherein each length is one of a time-based length, song-based length, and a distance-based length.

10. The system of claim 1, further comprising an overlay and cue module for generating and overlaying one or more of coaching tools, voice cues, and performance cues.

11. The system of claim 1, further comprising a social media module for sharing activity data with one or more users, obtaining a message from one or more of the users, and presenting each message via a user interface module.

12. A method for generating an audio experience, the method comprising:
obtaining a tempo value of an activity;
identifying one or more songs characterized by a tempo that matches the obtained tempo value; and
generating a playlist of songs that match the obtained tempo value.

13. The method of claim 12, further comprising determining a tempo value corresponding to a defined activity.

14. The method of claim 12, wherein the tempo based on physical movements of a user.

15. The method of claim 12, further comprising selecting songs that are characterized by the tempo that matches the obtained tempo value and that are consistent with one or more user preferences.

16. The method of claim 12, further comprising adjusting a tempo of a song.

17. The method of claim 12, further comprising adjusting a tempo of one or more portions of a song to match a rhythmic grid.

18. The method of claim 12, further comprising synchronizing beats of two or more sequential songs.

19. The method of claim 12, further comprising generating a playlist of songs that conforms to a plurality of intervals, each interval characterized by a defined length and a tempo.

20. The method of claim 12, further comprising generating and overlaying one or more of coaching tools, voice cues, and performance cues.

21. The method of claim 12, further comprising sharing activity data with one or more users, obtaining a message from one or more of the users, and presenting each message via a user interface module.

22. A non-transitory computer-readable medium embodying instructions that, when executed by a processor, perform operations comprising:
obtaining a tempo value of an activity;
identifying one or more songs characterized by a tempo that matches the obtained tempo value; and
generating a playlist of songs that match the obtained tempo value.
